(19) United States
(12) Patent Application Publication
(10) Pub. No.: US 2025/0024312 A1
(43) Pub. Date: Jan. 16, 2025

(54) ENHANCED QUALITY OF SERVICE SUPPORT FOR MOBILE WIRELESS NETWORKS

(71) Applicant: Verizon Patent and Licensing Inc., Basking Ridge, NJ (US)

(72) Inventors: Lixia Yan, Basking Ridge, NJ (US); Ratul K. Guha, Warwick, PA (US); Lalit R. Kotecha, San Ramon, CA (US); Sudhakar Reddy Patil, Flower Mound, TX (US)

(21) Appl. No.: 18/351,714

(22) Filed: Jul. 13, 2023

(51) Int. Cl. H04W 28/02; H04W 68/00; H04W 76/15

(52) U.S. Cl. CPC H04W 28/0268; H04W 68/00; H04W 76/15

(57) ABSTRACT

A system may receive, by a first network device in an access network, a request to setup a radio access bearer (RAB) for use in establishing a connection with a user equipment (UE), wherein the request includes at least one Quality-of-Service (QOS) attribute associated with the request. The first network device may determine that the at least one QoS attribute is not supported by the access network and may send a notification that RAB setup has failed to a second network device in a core network, wherein the notification includes a cause indicator that indicates that the failure is caused by an unsupported QoS. In response, the core network may modify the request to include a default quality of service attribute that is supported by the access network and may send the modified request to the first network device.

### BACKGROUND INFORMATION

Mobile wireless communication systems have finite resources which are typically shared among users and a variety of services. Different types of applications using these services can place varied demands on the wireless network. To address these demands, Quality-of-Service (QOS) management techniques may partition available network resources to provide sufficient service for all the applications. Conventional QoS management techniques rely on relative priorities which are based on QoS Class Identifiers (QCIs) for scheduling packets. However, modern wireless communication systems may support neutral host networking in which multiple network operators share certain network infrastructure elements. Such neutral host networking arrangements can impact certain aspects of the interrelationship between various network elements, rendering consistency in implementing all QoS features challenging.

### BRIEF DESCRIPTION OF THE DRAWINGS

FIG. 1 is a diagram illustrating an exemplary network environment consistent with an embodiment;

FIG. 2 is a block diagram of an exemplary system having an access network and a core network based on a Long-Term Evolution (LTE) standard;

FIG. 3 is a block diagram showing exemplary system having an access network and a core network based on a Fifth Generation (5G) standard;

FIGS. 4A and 4B illustrate exemplary message flows within a networking system for performing unsupported QoS handling during radio access bearer setup, consistent with the embodiment of FIG. 2;

FIGS. 5A and 5B illustrate exemplary message flows within a networking system for performing unsupported QoS handling during radio access bearer setup, consistent with the embodiment of FIG. 3;

FIG. 6 is a flowchart of a process for performing unsupported QoS handling during radio access bearer setup; and

FIG. 7 is a block diagram showing exemplary components of a network device according to an embodiment.

### DETAILED DESCRIPTION OF PREFERRED EMBODIMENTS

The following detailed description refers to the accompanying drawings. The same reference numbers in different drawings identify the same or similar elements.

Mismatches or inconsistencies between Quality-of-Service (QOS) capabilities supported by host core network components and access networks which connect to such host core networks may cause failures during data session establishment. Implementations described herein relate to systems and methods for handling certain unsupported QoS attributes associated with a Packet Data Network (PDN) session request from a user device. In particular, an access network, such as a private or enterprise access network, may receive a radio access bearer setup request that includes unsupported QoS requirements, such as a QoS class identifier (QCI) or 5G QoS Identifier (5QI).

In response, the access network may determine that the bearer setup request includes unsupported QoS requirements. However, instead of simply rejecting or failing the setup request, the access network may send a response, to the core network, that identifies the cause of the failure as being based on an unsupported QoS type. In response, rather than deleting the session request, the core network may modify the QoS attributes associated with the PDN session request and resend the modified setup request to the access network for processing. Upon receipt of the modified setup request, the access network may establish the setup of the requested radio access bearer and negotiate a bearer context with the user device.

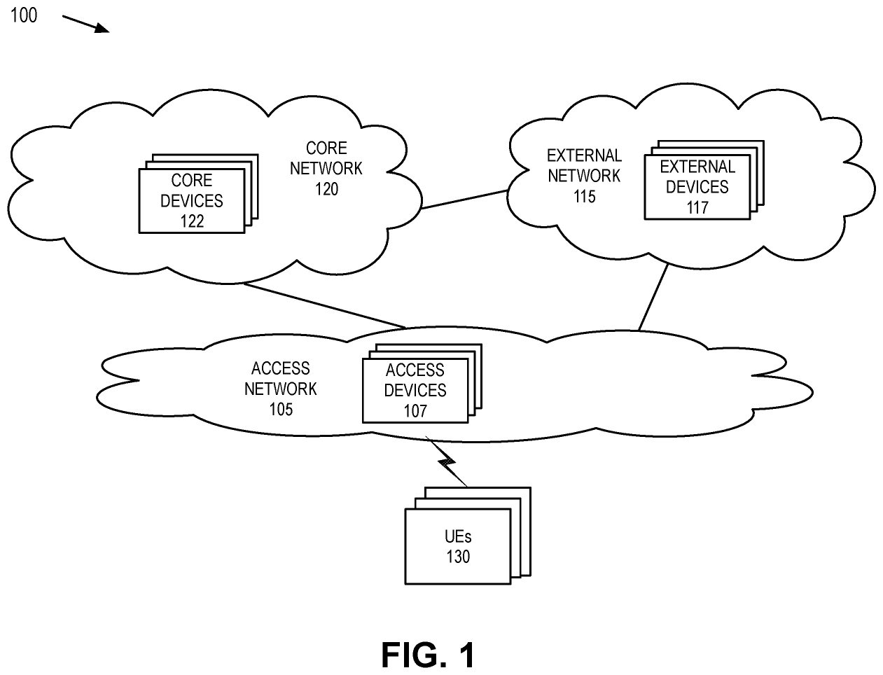

FIG. 1 is a diagram illustrating an exemplary network environment 100 consistent with implementations described herein. As illustrated, environment 100 includes a plurality of access networks 105, an external network 115, and a core network 120. Environment 100 further includes user equipment devices (UEs) 130-A to 130-N (referred to herein collectively as “UEs 130” and individually as “UE 130”).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into various types of network architectures (e.g., Software Defined Networking (SDN), virtual, logical, network slice, etc.). The number, the type, and the arrangement of network devices, and the number of UEs 130 are exemplary. For purposes of description, UEs 130 are not considered a network device.

Environment 100 includes communication links between the networks, between the network devices, and between UEs 130 and the network/network devices. Environment 100 may be implemented to include wired, optical, and/or wireless communication links. A connection via a communication link may be direct or indirect. For example, an indirect connection may involve an intermediary device and/or an intermediary network not illustrated in FIG. 1. direct connection may not involve an intermediary device and/or an intermediary network. The number, type, and arrangement of communication links illustrated in environment 100 are exemplary.

Access networks 105 may include one or multiple networks of one or multiple types and technologies. As described herein, access networks 105 may include one or more private or enterprise access networks that provide network connectivity to UEs 130. Such an environment may be referred to as neutral host networking, in which individual access networks 105 integrate with or leverage at least a portion of a common core network 120. In implementations consistent with embodiments described herein, at least a portion of access network 105 may include an LTE access network (e.g., an evolved packet core (EPC) network). Furthermore, access network 105 may include an LTE Advanced (LTE-A) access network and/or a Fifth Generation (5G) access network or other advanced network that includes advanced functionality, such as 5G new radio (NR) base station functionality; carrier aggregation; advanced or massive multiple-input and multiple-output (MIMO) functionality (e.g., functionality that involves an 8×8 antenna configuration, a 16×16 antenna configuration, a 256×256 antenna configuration, etc.); cooperative MIMO (CO-MIMO); relay station functionality; functionalities of Heterogeneous Networks (HetNets) of overlapping small cells and macrocells; Self-Organizing Network (SON) functionality; MTC functionality, such as 1.4 MHz wide enhanced MTC (eMTC) channels (also referred to as category Cat-M1) functionality, functionalities of Low Power Wide Area (LPWA) technology such as Narrow Band (NB) IoT (NB-IoT) technology, and/or other types of MTC technology; and/or other types of LTE-A and/or 5G functionality.

As described herein, access network 105 may include access devices 107 (referred to herein collectively as “access devices 107” and individually as “access device 107”). Each access device 107 may service a set of UEs 130. In particular, consistent with implementations described herein, access devices 107 may include a 4G base station (e.g., an evolved NodeB (eNodeB)), a 5G base station (gNodeB), or another advanced wireless base station.

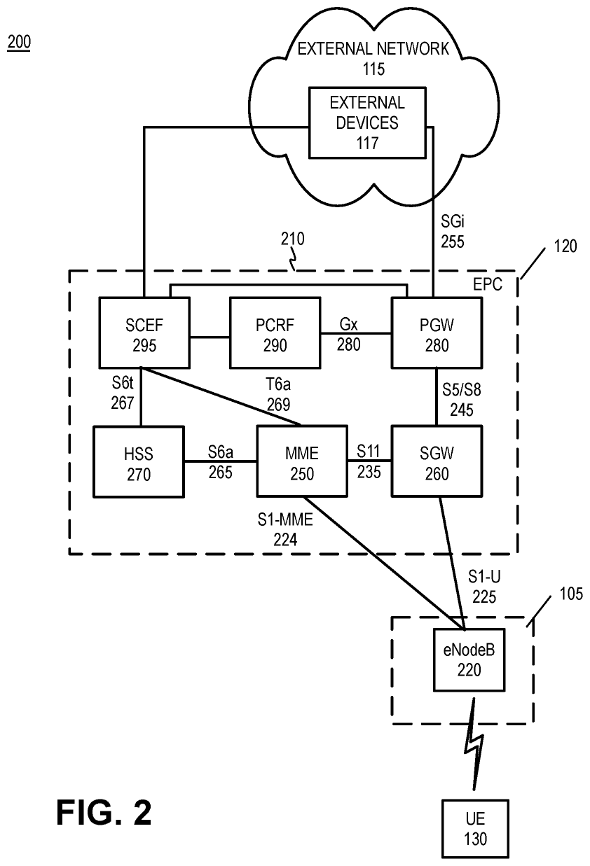

Core network 120 may include one or multiple networks of one or multiple network types and technologies. Core network 120 may include a complementary network of access network 105. For example, consistent with embodiments described herein, core network 120 may be implemented to include an Evolved Packet Core (EPC) of an LTE network, an LTE-Advanced (LTE-A) network, and/or an LTE-A Pro network, a 5G core (5GC) network, a future generation core network (e.g., a 5.5G, a 6G, a 7G, or another generation of core network), and/or another type of core network. Depending on the implementation, core network 120 may include various types of network devices that are illustrated in FIG. 1 as core devices 122. One exemplary implementation of a core network configured in accordance with embodiments described herein is described below with respect to FIG. 2.

External network 115 may include any type of wide area network, a metropolitan area network (MAN), an optical network, a video network, a satellite network, a wireless network (e.g., a Code Division Multiple Access (CDMA) network, a general packet radio service (GPRS) network, an LTE network, and/or a 5G network), an ad hoc network, a telephone network (e.g., the Public Switched Telephone Network (PSTN) or a cellular network), an intranet, or a combination of networks. Some or all of external network 115 may be managed by a provider of communication services that also manages access network 105, core network 120, and/or UEs 130. External network 115 may allow the delivery of IP and/or non-IP services to/from UEs 130 and may interface with other external networks. External network 115 may include one or more server devices and/or network devices, or other types of computation or communication devices. In some implementations, external network 115 may include an IP Multimedia Sub-system (IMS) network (not shown in FIG. 1). An IMS network may include a network for delivering IP multimedia services and may provide media flows between UEs 130 and external IP networks or external circuit-switched networks (not shown in FIG. 1).

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by UEs 130. By way of further example, external devices 117 may include mass storage devices, data center devices, NFV devices, SDN devices, cloud computing devices, platforms, and other types of network devices.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), higher user mobility (e.g., high speed train, remote computing, moving hot spots, etc.), IoTs (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), voice, conferencing, instant messaging), video streaming, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

UEs 130 may include any device with wireless communication functionality (e.g., cellular communication functionality). For example, each UE 130 may be implemented as a mobile device, a portable device, a stationary device (e.g., a non-mobile device and/or a non-portable device), a device operated by a user, or a device not operated by a user. For example, UE 130 may be implemented as a smartphone, a mobile phone, a personal digital assistant, a tablet, a netbook, a phablet, a wearable device (e.g., a watch, glasses, etc.), a computer, a gaming device, a music device, an IoT device, a drone, a smart device, or other type of wireless device (e.g., other type of user equipment (UE)). UEs 130 may be configured to execute various types of software (e.g., applications, programs, etc.). The number and the types of software may vary among UEs 130.

UEs 130 may support one or multiple Radio Access Technologies (RATs) (e.g., 4G, 5G, and/or future generation RAT), use various portions of the radio spectrum (e.g., multiple frequency bands, multiple carrier frequencies, licensed, unlicensed, mm wave, above mm wave, cm wave, etc.), be serviced by various levels and genres of network slicing, use DC service, use CA service, and/or use other types of connectivity services. Additionally, UEs 130 may include one or multiple communication interfaces that provide one or multiple (e.g., simultaneous, interleaved, etc.) connections via the same or different RATs, frequency bands, carrier frequencies, network slices, and/or via another communication medium (e.g., wired, etc.). For example, UEs 130 may be configured to support network access via both one or more private access networks operators (referred to as radio network operators (RNOs)) as well as via a general mobile network operator (MNO) access network, which may share at least a portion of core network 120.

Although FIG. 1 shows exemplary components of environment 100, in other implementations, environment 100 may include fewer components, different components, differently arranged components, or additional functional components than depicted in FIG. 1. Additionally, or alternatively, one or more components of environment 100 may perform functions described as being performed by one or more other components of environment 100.

FIG. 2 is a block diagram of a network 200 having a core network 120 based on the LTE standard, referred to herein as evolved packet core (EPC) 210. In this implementation, as shown, access network 105 may include a private LTE network that includes at least one eNodeB 220. UE 130 and eNodeB 220 may exchange data over a RAT based on LTE air interface protocols. In the embodiment shown in FIG. 2, core network 120 may operate in conjunction with an evolved Universal Mobile Telecommunications System (UMTS) Terrestrial Network (eUTRAN) that includes at least one eNodeB 220. Network 200 may further include an Internet Protocol (IP) network and/or a non-IP network, which may be embodied separately or included in a backhaul network (not shown) and/or in external network 115.

Core network 120 may include one or more devices that are physical and/or logical entities interconnected via standardized interfaces. Core network 120 may provide wireless packet-switched services and wireless packet connectivity to user devices to provide, for example, data, voice, and/or multimedia services. Core network 120 may further include a Mobility Management Entity (MME) 250, a serving gateway (SGW) 260, a home subscriber server (HSS) 270, a packet data network gateway (PGW) 280, a Policy and Charging Rules Function (PCRF) 290, and a Service Capability Exposure Function (SCEF) 295. FIG. 2 depicts a representative network 200 with exemplary components and configuration shown for purposes of explanation. Other embodiments may include additional or different network entities in alternative configurations than which are exemplified in FIG. 2.

Further referring to FIG. 2, eNodeB 220 may include one or more devices and other components having functionality that allows UE 130 to wirelessly connect to eNodeB 220. eNodeB 220 may be configured to receive bearer (e.g., E-UTRAN Radio Access Bearer (E-RAB)) setup request messages from MME 250 that include, among other items, a QCI. QCI is an identifier associated with a particular QoS class of service. Different types of traffic and/or different subscriber types require different QoS and therefore different QCI values. Consistent with implementations described herein, eNodeB 220 may be configured to determine whether a QCI value included in an E-RAB setup request message is unrecognized or unsupported. In response, eNodeB 220 may send an E-RAB setup response message to MME 250 that indicates a failure to set up the E-RAB and that further indicates that the cause for the failure is an unsupported QCI (or other QoS-related requirement attribute).

eNodeB 220 may interface with core network 120 via a SI interface, which may be split into a control plane S1-MME interface 224 and a data plane S1-U interface 225. eNodeB 220 may interface with MME 250 via S1-MME interface 224, and interface with SGW 260 via S1-U interface 225. S1-U interface 225 may be implemented, for example, using the GPRS Tunneling Protocol (GTP). S1-MME interface 224 may be implemented, for example, with a protocol stack that includes a Non-Access Stratum (NAS) protocol and/or Stream Control Transmission Protocol (SCTP).

MME 250 may implement control plane processing for access network 105. For example, through eNodeB 220, MME 250 may activate and deactivate bearers for UE 130. MME 250 may also select a particular SGW 260 for a particular UE 130. MME 250 may interface with other MMEs (not shown) in EPC 210 and may send and receive information associated with UEs 130, which may allow one MME 250 to take over control plane processing of UEs 130 serviced by another MME 250, if the other MME becomes unavailable.

Consistent with implementations described herein, MME 250 may, in response to a E-RAB setup failure message from eNodeB 220, forward a modification request message, to the SGW 260/PGW 280, that includes the unsupported QCI indication.

SGW 260 may provide an access point to and from UE 130, may handle forwarding of data packets for UE 130, and may act as a local anchor point during handover procedures between eNodeBs 220. SGW 260 may interface with PGW 280 through an S5/S8 interface 245. S5/S8 interface 245 may be implemented, for example, using GTP. S5/S8 interface 245 may be used to create a session response or update bearer request.

PGW 280 may function as a gateway to external network 115 through a SGi interface 255. External network 115 may provide various services (e.g., firmware updates, over the top voice services, etc.) to UE 130. A particular UE 130, while connected to a single SGW 260, may be connected to multiple PGWs 280, one for each packet network with which UE 130 communicates. As described below PGW 280 may include a policy and charging enforcement function (PCEF) (not shown) that enforces policy decisions made by PCRF 290 by establishing bearers, mapping service data flows to bearers, and performing traffic policing and shaping

Consistent with implementations described herein, PCEF in PGW 280, in response to a bearer modification request message from MME 250 that includes an unsupported QCI cause indication, may transmit an update request message to PCRF 290 indicating the unsupported QCI and requesting modification of the requested bearer to a default or supported QCI.

MME 250 may communicate with SGW 260 through an S11 interface 235. S11 interface 235 may be implemented, for example, using GTPv2. S11 interface 235 may be used to create and manage a new session for a particular UE 130. S11 interface 235 may be activated when MME 250 needs to communicate with SGW 260, such as when the particular UE 130 attaches to EPC 210, when bearers need to be added or modified for an existing session for the particular UE 130, when a connection to a new PGW 280 needs to be created, or during a handover procedure (e.g., when the particular UE 130 needs to switch to a different SGW 260).

HSS 270 may store information associated with UE 130 and/or information associated with users of UE 130. For example, HSS 270 may store user profiles that include registration, authentication, and access authorization information. HSS 270 may additionally store information about UE 130, such as whether UE 130 is a high priority user device. MME 250 may communicate with HSS 270 through an S6a interface 265. S6a interface 265 may be implemented, for example, using a Diameter protocol.

PCRF 290 may provide policy control decision and flow based charging control functionalities. PCRF 290 may provide network control regarding service data flow detection, gating, QoS and flow based charging, etc. PCRF 290 may determine how a certain service data flow may be treated, and may ensure that user plane traffic mapping and treatment is in accordance with a user's subscription profile, based on, for example, a specified QCI. Policy control decisions generated by PCRF 290, known as Policy and Charging Control (PCC) rules, are forwarded to a PCEF in PGW 114. The PCEF enforces policy decisions by establishing bearers, mapping service data flows to bearers, and performing traffic policing and shaping.

Consistent with implementations described herein and as described briefly above, PCRF 290 may be further configured to send a credit control update message in the event of an unsupported QCI and may respond by associating a bearer having a default QCI with the requested session.

PCRF 290 may communicate with PGW 280 using a Gx interface 280. Gx interface 280 may be implemented, for example, using a Diameter protocol. Gx interface 280 may be used to introduce a list of new event triggers for monitoring network congestion. In addition, Gx interface 280 may be used to introduce a new attribute-value pair (AVP) to be used by eNodeB 220 to prioritize packets for a high priority user device during network congestion.

SCEF 295 may include a network or computational device that provides exposure of 3GPP network service capabilities to third party applications. Specifically, SCEF 295 may provide network events through application programming interfaces (APIs) to external applications which may reside on external devices 117 and/or UEs 130. Exposure of the various events may include, for example: a change in UE 130 reachability; UE 130 loss of connectivity; UE 130 location reporting; UE 130 roaming status change; communication failure; and change of international mobile equipment identifier-international mobile subscriber identifier (IMEI-IMSI) association. In one implementation, SCEF 295 may exchange control plane signaling with MME 250 (via a Toa interface 269 using Diameter protocol) and/or HSS 270 (via an Sh or S6t interface 267). In one implementation, SCEF 295 may be included as part of a control plane bearer path between UE 130 and external devices 117. According to an implementation described herein, SCEF 295 may act as a gateway for connecting UE 130 to external devices 117. Generally, SCEF 295 may expose APIs for multiple application servers (such as external devices 117) to access network services to communicate with UEs 130. SCEF 295 may communicate with MME 250 via a modified Toa interface relative to a standardized T6a interface.

While FIG. 2 shows exemplary components of network 200, in other implementations, network 200 may include fewer components, different components, differently arranged components, or additional components than depicted in FIG. 2. Additionally, or alternatively, one or more components of network 200 may perform functions described as being performed by one or more other components of network 200.

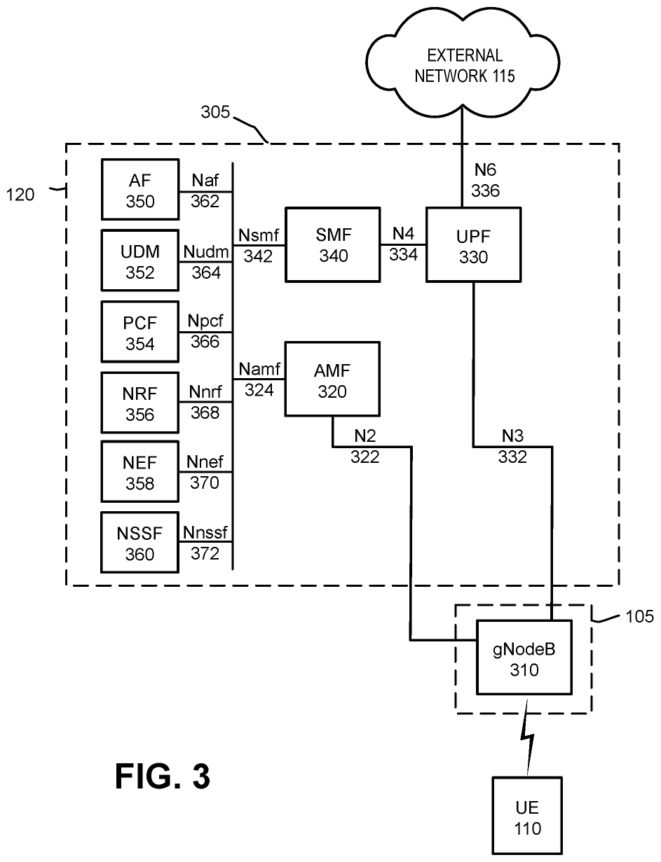

FIG. 3 is a block diagram of a network 300 having a core network 120 based on the 5G standard, referred to as 5G core (5GC) 305. In this implementation, as shown, access network 105 may include a private 5G network that includes at least one gNodeB 310.

As shown 5GC 305, may include an Access and Mobility Management Function (AMF) 320, a User Plane Function (UPF) 330, a Session Management Function (SMF) 340, an Application Function (AF) 350, a Unified Data Management (UDM) 352, a Policy Control Function (PCF) 354, a Network Repository Function (NRF) 356, a Network Exposure Function (NEF) 358, and a Network Slice Selection Function (NSSF) 360. While FIG. 3 depicts a single gNodeB 310, AMF 320, UPF 330, SMF 340, AF 350, UDM 352, PCF 354, NRF 356, NEF 358, and/or NSSF 360 for exemplary illustration purposes, in practice, network 300 may include multiple gNodeBs 310, AMFs 320, UPFs 330, SMFs 340, AFs 350, UDMs 352, PCFs 354, NRFs 356, NEFs 358, and NSSFs 360.

gNodeB 310 may include one or more devices (e.g., base stations or access devices 107) and other components and functionality that enable UEs 130 to wirelessly connect to access network 105/core network 120 using 5G NR Radio Access Technology (RAT). For example, gNodeB 310 may include one or more cells, with each cell including a wireless transceiver with an antenna array configured for millimeter-wave wireless communication. gNodeB 310 may implement one or more RAN slices to partition access network 105/core network 120. gNodeB 310 may communicate with AMF 320 using an N2 interface 322 and communicate with UPF 330 using an N3 interface 332.

gNodeB 310 may be configured to receive data radio bearer (DRB) setup request messages from AMF 320 that include, among other items, a 5G QoS Identifier (5QI). 5QI is an identifier associated with a particular QoS class of service. Different types of traffic and/or different subscriber types require different QoS and therefore different QCI values. Consistent with implementations described herein, gNodeB 310 may be configured to determine whether one or more QoS values included in a DRB setup request message is unrecognized or unsupported. In response, gNodeB 310 may send a response message to AMF 320 that indicates a failure to set up the data bearer and that further indicates that the cause for the failure is an unsupported QoS-related requirement attribute.

AMF 320 may perform registration management, connection management, reachability management, mobility management, lawful intercepts, Short Message Service (SMS) transport between UEs 130 and an SMS function (not shown in FIG. 3), session management messages transport between UEs 130 and SMF 340, access authentication and authorization, location services management, functionality to support non-3GPP access networks, and/or other types of management processes. In some implementations, AMF 320 may implement some or all of the functionality of managing RAN slices in gNodeB 310. AMF 320 may be accessible by other function nodes via a Namf interface 324.

UPF 330 may maintain an anchor point for intra/inter-RAT mobility, maintain an external Packet Data Unit (PDU) point of interconnect to a data network (e.g., external network 115), perform packet routing and forwarding, perform the user plane part of policy rule enforcement, perform packet inspection, perform lawful intercept, perform traffic usage reporting, enforce QoS policies in the user plane, perform uplink traffic verification, perform transport level packet marking, perform downlink packet buffering, send and forward an “end marker” to a Radio Access Network (RAN) node (e.g., gNodeB 310), and/or perform other types of user plane processes. UPF 330 may communicate with SMF 340 using an N4 interface 334 and connect to external network 115 using an N6 interface 336.

SMF 340 may perform session establishment, modification, and/or release, perform IP address allocation and management, perform Dynamic Host Configuration Protocol (DHCP) functions, perform selection and control of UPF 330, configure traffic steering at UPF 330 to guide traffic to the correct destination, terminate interfaces toward PCF 354, perform lawful intercepts, charge data collection, support charging interfaces, control and coordinate of charging data collection, termination of session management parts of network access stratum (NAS) messages, perform downlink data notification, manage roaming functionality, and/or perform other types of control plane processes for managing user plane data. SMF 340 may be accessible via an Nsmf interface 342.

AF 350 may provide services associated with a particular application, such as, for example, application influence on traffic routing, accessing NEF 358, interacting with a policy framework for policy control, and/or other types of applications. AF 350 may be accessible via a Naf interface 362.

UDM 352 may maintain subscription information for UEs 130, manage subscriptions, generate authentication credentials, handle user identification, perform access authorization based on subscription data, perform network function registration management, maintain service and/or session continuity by maintaining assignment of SMF 340 for ongoing sessions, support SMS delivery, support lawful intercept functionality, and/or perform other processes associated with managing user data.

PCF 354 may support policies to control network behavior, provide policy rules to control plane functions (e.g., to SMF 340), access subscription information relevant to policy decisions, execute policy decisions, and/or perform other types of processes associated with policy enforcement. PCF 354 may be accessible via Npcf interface 366. PCF 354 may specify QoS policies based on QoS flow identity (QFI) and or 5QI values consistent with 5G network standards. Consistent with implementations described herein, PCF 354 may be further configured to respond to notifications regarding unsupported QoS values and may respond by associating modifying the QoS values for the requested session based on the of the capabilities access network.

NRF 356 may support a service discovery function and maintain a profile of available network function (NF) instances and their supported services. An NF profile may include an NF instance identifier (ID), an NF type, a Public Land Mobile Network (PLMN) ID associated with the NF, a network slice ID associated with the NF, capacity information for the NF, service authorization information for the NF, supported services associated with the NF, endpoint information for each supported service associated with the NF, and/or other types of NF information. NRF 356 may be accessible via an Nnrf interface 368.

NEF 358 may expose capabilities, events, and/or status to other NFs, including third party NFs, AFs, edge computing NFs, and/or other types of NFs. For example, NEF 358 may provide capabilities and events/status of UEs 130 to AS 150. Furthermore, NEF 358 may secure provisioning of information from external applications to access network 120, translate information between access network 120 and devices/networks external to access network 120, support a Packet Flow Description (PFD) function, and/or perform other types of network exposure functions. NEF 358 may be accessible via Nnef interface 370.

NSSF 360 may select a set of network slice instances to serve a particular UE 110, determine network slice selection assistance information (NSSAI), determine a particular AMF 320 to serve a particular UE 130, and/or perform other types of processes associated with network slice selection or management. In some implementations, NSSF 360 may implement some or all of the functionality of managing RAN slices in gNodeB 310. NSSF 360 may be accessible via Nnssf interface 372.

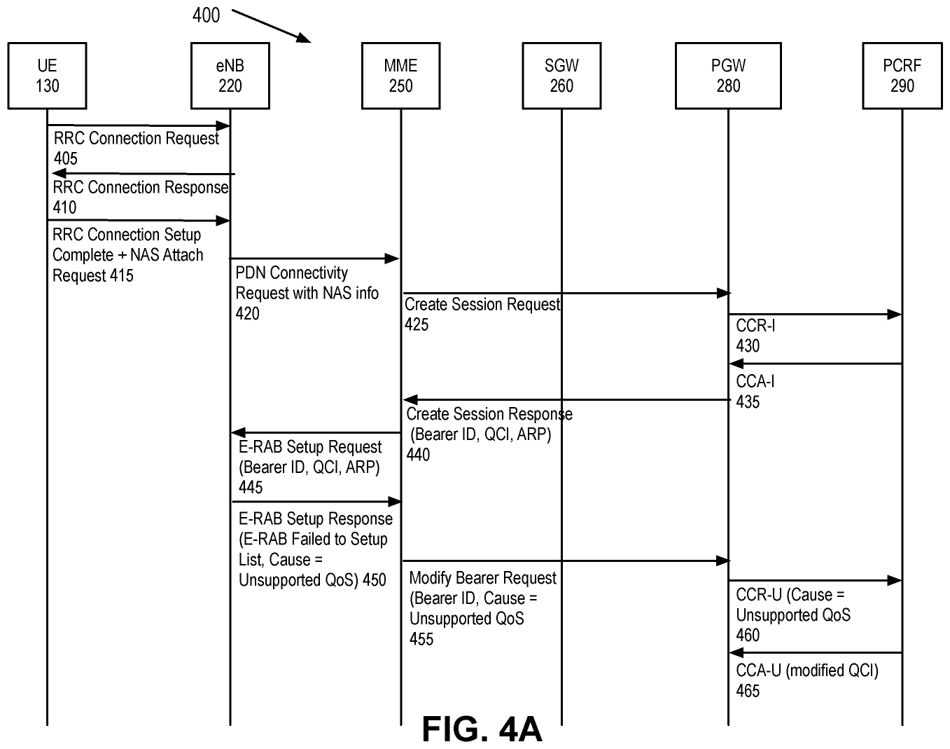

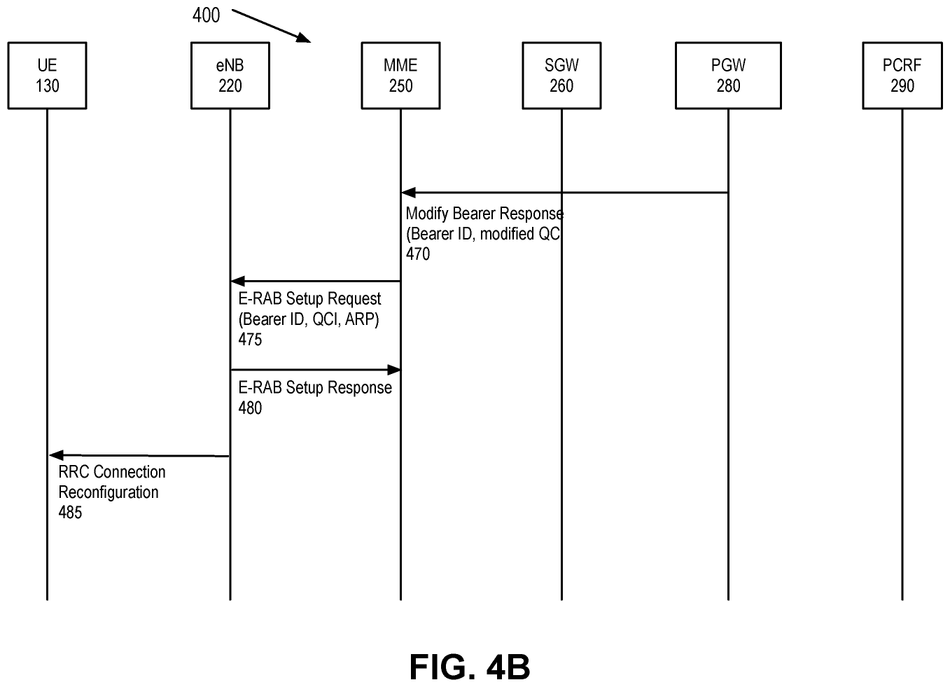

FIGS. 4A and 4B depict a diagram illustrating exemplary communications 400 between devices in network environment 100. Communications in FIGS. 4A and 4B represent communications for performing unsupported QoS handling during radio access bearer setup. In the following example, network environment 100 may correspond to LTE EPC 210 and eUTRAN/eNodeB 220. The messages explained and illustrated are exemplary and do not represent each and every message that may be exchanged during a network attachment or connection request procedure. For example, a random access channel (RACH) procedure, which is not illustrated in FIGS. 4A and 4B, may take place before a radio resource control (RRC) connection establishment procedure.

Referring to FIG. 4A, UE 130 and eNodeB 220 exchange messages to establish an RRC connection, as illustrated by RRC Connection Request message (405) from UE 130 to eNodeB 220, a responsive RRC Connection Setup message (410) from eNodeB 220 to UE 130, and an RRC Connection Setup Complete message (415) from UE 130 to eNodeB 220, which may also include a non-access stratum (NAS) attach request indicating a PDN connectivity request. The RRC Connection Setup Complete/PDN connectivity request message (415) identifies the PDN type, the Access Point Name (APN), and various Protocol Configuration Options (PCOs).

Once the initial RRC connection has been established, eNodeB 220 may forward any NAS data received from UE 130 to MME 250, which includes the PDN connectivity request message (420). In response to receiving PDN connectivity request (420), MME 250 may generate a Create Session Request message (425) that includes the information in the PDN connectivity request that is relevant to session creation. MME 250 may transmit the Create Session Request message (425) to PGW 280 via SGW 260.

In response to receiving Create Session Request message (425), PGW 280 may transmit a credit control request initial (CCR-I) message (430) to PCRF 290 with information about the subscriber and the requested PDN session. In response, PCRF 290 may retrieve PCC rules associated with the subscriber and generate and transmit a credit control answer initial (CCA-I) message (435) back to PGW 280 that identifies a radio bearer for use (e.g., Default-EPS-Bearer) and any QoS information relating to the subscriber and the requested session. The QoS information may include a QCI and an Allocation and Retention Policy (ARP) associated with the subscriber and the requested PDN session. For the purposes of this example, assume that the QCI value returned in the CCA-I message (435) is not supported by the access network 105 and eNodeB 220 to which UE 130 is connecting. Upon receipt of the CCA-I message (435), PGW 280 may send, via SGW 260, a Create Session Response message (440) to MME 250 that identifies the radio access bearer (bearer ID) as well as any associated bearer QoS identifiers, such as the QCI and the ARP.

MME 250 may then generate and transmit an E-RAB Setup Request message (445) to eNodeB 220 that identifies a bearer (e.g., a default or dedicated bearer) to be used for the PDN session, as well as any QoS identifiers associated with the subscriber, such as the QCI and the ARP. As described above, for the purposes of this example, assume that eNodeB 220 is part of a private or access network 105 that is leveraging core network 120 associated with a mobile network operator (MNO). Further assume that access network 105 does not support the QCI (or ARP) included in the E-RAB Setup Request message (445). In this scenario, under traditional LTE session creation processing, a mismatch between QoS identifiers included in the request message and the capability of the eNodeB 220 would result in eNodeB 220 generating and sending an E-RAB Setup Response message to MME 250 that includes the requested E-RAB in a failed to setup list without a valid cause information element (IE). Upon receipt of such an E-RAB Setup Response message, MME 250 would initiate session request deletion and the PDN connectivity request would be rejected, rendering UE 130 unable to connect to access network 105 and core network 120.

However, consistent with implementations described herein, access network 105 and core network 120 may be configured to recognize an E-RAB setup failure cause based on one or more unsupported QoS identifiers. In particular, as shown in FIG. 4A, eNodeB 220 may determine that at least one QoS identifier (e.g., the QCI) included within the E-RAB Setup Request Message is not supported. In response, eNodeB 220 may generate and transmit an E-RAB Setup Response message (450) to MME 250 that includes the requested E-RAB in a failed to setup list and includes a cause identifier IE corresponding to the unsupported QoS attribute.

Upon receipt of the E-RAB Setup Response message (455), MME may recognize the Unsupported QoS cause identifier IE and transmit a Modify Bearer Request message (460) to PGW 280 via SGW 260. The Modify Bearer Request message (460) identifies the contexts to be modified, which include the E-RAB identifier and the Unsupported QoS cause. In response, PGW 280 may generate and transmit a CCR-update (CCR-U) message (460) to PCRF 290 that includes the Unsupported QoS cause as the update event trigger. PCRF 290 may generate and transmit a CCA-update (CCA-U) message (465) back to PGW 280. The message may identify the E-RAB and include modified default QoS identifiers (e.g., QCI values) known to be supported by all eNodeBs 220. For example, CCA-U message (465) may include a QCI value of 8.

As shown in FIG. 4B, upon receipt of CCA-U message (465) which includes the updated QCI value, PGW 280 may generate and transmit a Modify Bearer Response message (470) to MME 250 via SGW 260. The Modify Bearer Response message (470) may identify updated bearer setup information, which includes the E-RAB identifier, and the updated QoS information (e.g., QCI and/or ARP). MME 250 may then generate and transmit a new E-RAB Setup Request message (475) to eNodeB 220 that includes the updated bearer information, including the updated default QCI value, to be used for the PDN session.

With the E-RAB setup request message (475) including supported QoS (e.g., QCI) information, eNodeB 220 may activate the E-RAB with UE 130 by, for example, transmitting an E-RAB Setup Response message (480) to MME 250 and performing RRC Connection Reconfiguration with UE 130 to activate the default EPS bearer (485).

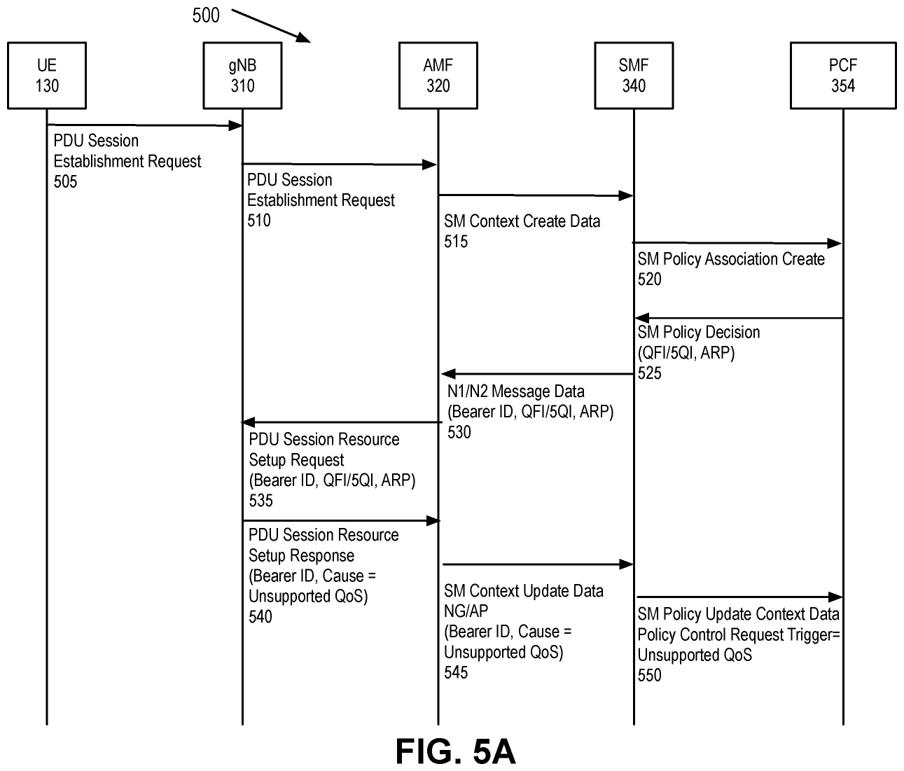

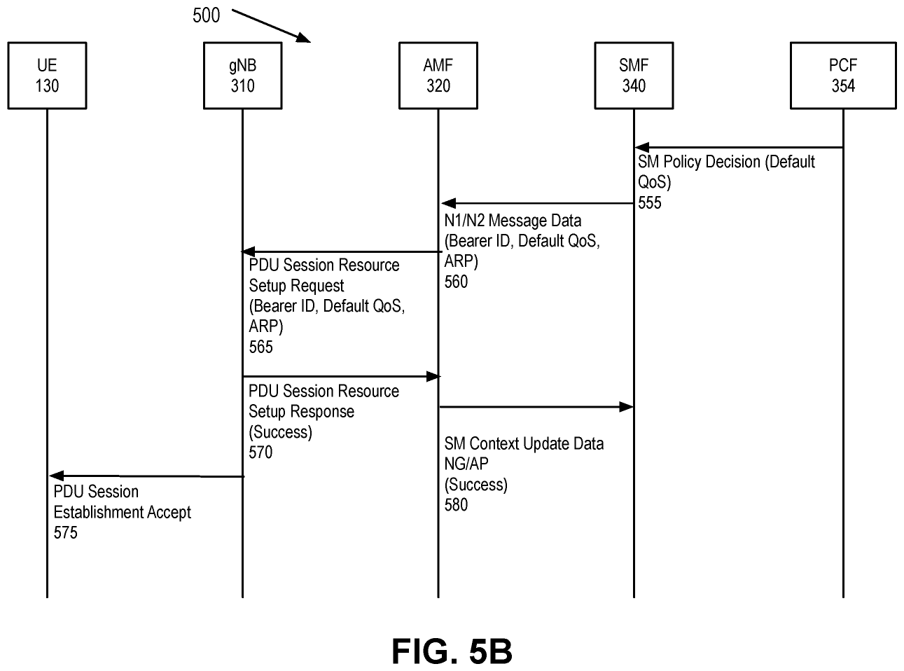

FIGS. 5A and 5B depict a diagram illustrating exemplary communications 500 between devices in network environment 100. Communications in FIGS. 5A and 5B represent communications for performing unsupported QoS handling during radio resource setup. In the following example, network environment 100 may correspond to 5GC 305 and gNodeB 310. The messages explained and illustrated are exemplary and do not represent each and every message that may be exchanged during a network attachment or connection request procedure.

Referring to FIG. 5A, UE 130 and gNodeB 220 exchange messages to establish an PDU session, as illustrated by PDU Session Establishment Request (505) from UE 130 to gNodeB 310, which includes a non-access stratum (NAS) information that identifies the PDN type, the Data Network Name (DNN), any requested network slice information (e.g., Network Slice Selection Assistance Information (NMSSAI), etc.

In response, gNodeB 310 may forward any NAS data received from UE 130 to AMF 320, which includes the PDU Session Establishment Request message (510). In response to receiving PDU Session Establishment Request message (510), AMF 320 may generate and transmit a POST request to SMF 340 that requests creation of a session management (SM) context, referred to as SM Context Create Data (515). SM Context Create Data (515) includes a representation of the individual SM context resource to be created among other information elements.

In response to receiving the context creation request message, SMF 340 may send a request (520) for creation of a SM policy association to PCF 354. The SM policy association request identifies the UE 130 and the PDU session to be created among other information elements. In response, PCF 354 may retrieve information regarding any policies applicable to UE 130 and the requested PDU session, including relevant QoS attributes (e.g., from UDM 352, etc.) and generate and transmit a SM Policy Decision message (525) back to SMF 340 that identifies, among other information, the applicable QoS attributes (e.g., QFI, 5QI, etc.). For the purposes of this example, assume that the QoS attributes returned in the SM Policy Decision message (525) are not supported by the access network 105 and gNodeB 310 to which UE 130 is connecting. Upon receipt of SM Policy Decision message (525), SMF 340 may a message data message (530) to AMF 320 that includes the associated QoS identifiers.

AMF 320 may then generate and transmit an PDU Session Resource Setup Request message (535) to gNodeB 310 that identifies information elements required to set up the necessary resources at gNodeB 310, as well as any QoS identifiers associated with the subscriber, such as the QFI, 5QI, and the ARP. As described above, for the purposes of this example, assume that gNodeB 310 is part of a private or access network 105 that is leveraging core network 120 associated with a mobile network operator (MNO). Further assume that access network 105 does not support one or more of the QoS attributes included in the PDU Session Resource Setup Request message (535). In this scenario, under traditional 5G session establishment processing, a mismatch between QoS identifiers included in the request message and the capability of the gNodeB 310 would result in gNodeB 310 generating failure response that prevents establishment of the PDU session.

However, consistent with implementations described herein, access network 105 and core network 120 may be configured to recognize an PDU Session Resource Setup Request failure cause based on one or more unsupported QoS identifiers. In particular, as shown in FIG. 5A, gNodeB 310 may determine that at least one QoS identifier (e.g., the 5QI) included within the PDU Session Resource Setup Request message (535) is not supported. In response, gNodeB 310 may generate and transmit an PDU Session Resource Setup Response message (540) to AMF 320 that includes a failure cause identifier corresponding to the unsupported QoS attribute.

Upon receipt of the PDU Session Resource Setup Request message (540), AMF 320 may recognize the Unsupported QoS cause identifier and may transmit a SM Context Update Data message (545) to SMF 340. SM Context Update Data message (545) identifies the contexts to be modified, which include the resource identifier and the Unsupported QoS cause identifier. In response, SMF 340 may generate and transmit a SM Policy Update Context Data message (550) to PCF 354 that includes the Unsupported QoS cause as the update event trigger. In response, as shown in FIG. 5B, PCF 354 may generate and transmit an updated policy decision message (555) back to SMF 340 that identifies the PDU resource to be used and includes a modified default QoS identifier (e.g., 5QI value) known to be supported by all gNodeBs 310.

Upon receipt of the policy decision message (555) which includes the updated QoS value, SMF 340 may a transmit a data message (560) to AMF 320 that includes the modified default QoS identifiers. AMF 320 may then generate and transmit a modified PDU Session Resource Setup Request message (565) to gNodeB 310 that identifies information elements required to set up the necessary resources at gNodeB 310, as well as any updated or modified default QoS identifiers. In response, gNodeB 310 may determine accept the PDU Session Resource setup request and my return a success message (570) to AMF 320 and also communicate a PDU Session Establishment Accept message (575) to UE 130 that includes relevant information regarding establishment of a PDU session via gNodeB 310 and 5GC 305. AMF may generate and transmit a SM Context Update data message (580) to SMF 340 indicating successful establishment of the PDU session.

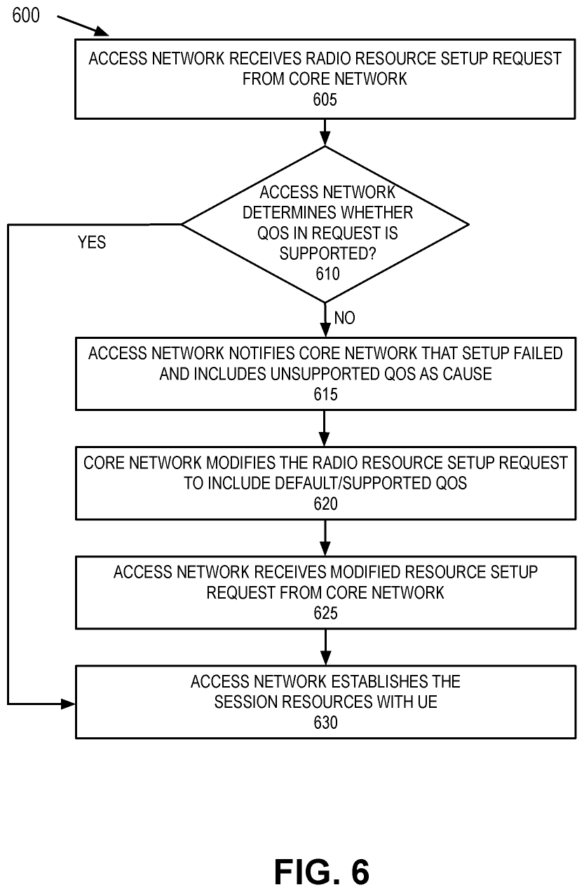

FIG. 6 is a flow diagram illustrating an exemplary process 600 for enabling support of initially unsupported QoS attributes in a radio access bearer request. In one implementation, process 600 may be performed by network devices in access network 105 and core network 120, as described above with respect to FIGS. 4A through 5B.

Process 600 may include access network 105 receiving a request from core network 120 to set up a radio bearer for a PDN session requested by a UE 130 (block 605). For example, consistent with FIGS. 4A and 4B, eNodeB 220 may receive an E-RAB Setup Message (450) that includes an E-RAB identifier and QoS information corresponding to the bearer setup request. In another implementation consistent with FIGS. 5A and 5B, gNodeB 310 may receive a PDU Session Resource Setup Request (535) that includes the QoS attributes associated with UE 130 by PCF 354, At block 610, the access network 105 may determine whether resources meeting the requested QoS are supported. For example, eNodeB 220 may determine whether the QCI and/or ARP requirements identified in the E-RAB Setup Message (450) are supported or gNodeB 310 may determine whether designated QFI/5QI requirements in the PDU Session Resource Setup Request (535) are supported. As described above, in some implementations access network 105 may be operated by an entity associated with (e.g., a customer), but separate from an operator of core network 120, such as an enterprise or private network. Such a relationship may be referred to as neutral host networking in which certain core network functions are provided by a mobile network operator (MNO) but access networks that interoperate with the core network are managed and operated by third parties, such as businesses, government entities, or other radio network operators (RNOs). In such an arrangement, features and aspects supported by the MNO or by the core network may not be supported by an RNO, either by intention or as a result of delays in performing access network updates or maintenance.

If the QoS requirements identified in the resource setup message are supported (block 610—YES), the process may continue to block 640, described below. However, if the QoS requirements identified in the resource setup message are not supported (block 610—NO), access network 105 may notify core network 120 that resource setup has failed. The notification may include a cause identifier that indicates that an unsupported QoS attribute is the cause for the failure (block 615). For example, eNodeB 220 may generate and transmit E-RAB Setup Response message (455) to MME 250 that includes the requested E-RAB in a failed to setup list and includes a cause identifier corresponding to the unsupported QoS attribute, e.g., the QCI value. Alternatively, gNodeB 310 may generate and transmit a PDU Session Resource Setup Response message (540) to AMF 320 that includes the cause identifier.

Next, upon receipt of a resource setup failure notification that includes the unsupported QoS cause identifier, core network 120 may modify the resource request to reset the QoS attributes for the requested PDN session to default attributes that are known to be supported by access network 105 (block 620). For example, as described above, MME 250 in core network 120 may generate and transmit Modify Bearer Request message (460) to PGW 280 via SGW 260 that identifies the bearer contexts to be modified, which include the E-RAB identifier and the Unsupported QoS cause. PGW 280 may then generate and transmit CCR-U message (460) that includes the Unsupported QoS cause and the E-RAB identifier to PCRF 290, which in turn may generate and transmit CCA-U message (465) back to PGW 280 that includes the default QoS information (e.g., QCI and/or ARP values). Upon receipt of CCA-U message (465), PGW 280 may generate and transmit Modify Bearer Response message (470) that identifies updated bearer setup information, which includes the E-RAB identifier, and the updated QoS information (e.g., QCI and/or ARP values). Consistent with the embodiment if FIGS. 5A and 5B, AMF 320 in core network 120 may generate and transmit SM Context Update Data message (545) to SMF 340 that identifies the unsupported QoS cause identifier. contexts to be modified. SMF 340 then generates a transmits SM Policy Update Context Data message (550) to PCF 354 that includes the Unsupported QoS cause as a policy request trigger. In response, PCF 354 generates and transmits a policy update decision (555) that includes the default QoS information (e.g., QFI, 5QI, and/or ARP values). Upon receipt of the policy update decision (555), SMF 340 may generate and transmit message data (560) to AMF 320, which includes the resource identifier, and the updated QoS information (e.g., QFI, 5QI, and/or ARP values).

At block 625, access network 105 may receive another request from core network 120 to setup a resource for the PDN session. Unlike the initial request received at block 605, the resource setup request of block 625 has been modified to include supported QoS attributes. For example, MME 250 may generate and transmit new E-RAB Setup Request message (475) to eNodeB 220 that includes the updated bearer information, including the updated default QCI value, to be used for the PDN session. Alternatively, AMF 320 may generate and transmit a new PDU Session Resource Setup Request message (565) to gNodeB 310 that includes the updated resource information, including the updated default QFI/5QI value(s), to be used for the PDN session.

At block 630, access network 105 may establish the requested resource with UE 130. For example, eNodeB 220 may activate the E-RAB with UE 130 by transmitting E-RAB Setup Response message (480) to MME 250 and performing RRC Connection Reconfiguration with UE 130 to activate the default EPS bearer (485). Alternatively, gNodeB 310 may establish the PDU session with UE 130 by transmitting successful resource setup response message (570) to AMF 320 and transmitting PDU Session Establishment Accept message (580) to UE 130 to activate the PDU session via the established resources.

Although the signal flow diagram of FIGS. 4A through 5B and the flow chart of FIG. 6 are described with respect to stand alone LTE and 5G network implementations, similar processes may be utilized in the context of a hybrid network approach.

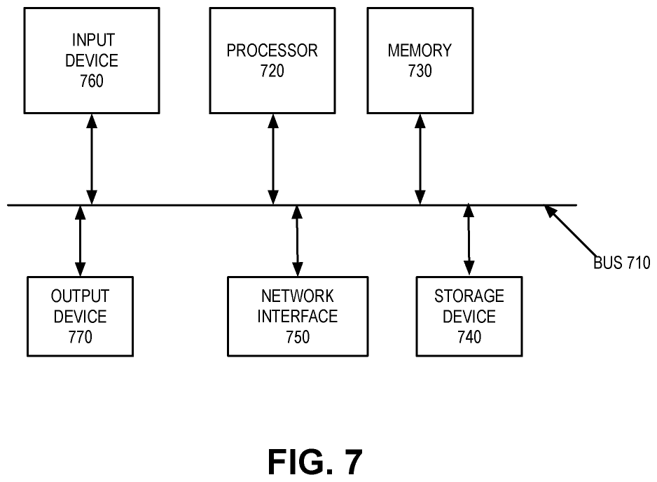

FIG. 7 is a block diagram showing exemplary components of a network device 600 according to an embodiment. Network device 600 may include one or more network elements illustrated in FIGS. 1-3, such as, for example, UE 130, external devices 117, MME 250, SGW 260, HSS 270, PGW 280, PCRF 290, SCEF 295, AMF 320, SMF 340, and PCF 354, etc. In some embodiments, there may be a plurality of network devices 700 providing functionality of one or more network elements. Alternatively, one network device 700 may perform the functionality of any plurality of network elements. Network device 700 may include a bus 710, a processor 720, a memory 730, storage device 740, a network interface 750, input device 760, and an output device 770.

Bus 710 provides a path that permits communication among the components of network device 700. Processor 720 may include any type of single-core processor, multi-core processor, microprocessor, latch-based processor, and/or processing logic (or families of processors, microprocessors, and/or processing logics) that interprets and executes instructions. In other embodiments, processor 720 may include an application-specific integrated circuit (ASIC), a field-programmable gate array (FPGA), and/or another type of integrated circuit or processing logic. For example, processor 720 may use any operating system, which may include varieties of the Windows, UNIX, and/or Linux operating systems. Processor 720 may also use high-level analysis software packages and/or custom software written in any programming and/or scripting languages for interacting with other network entities are communicatively coupled to external network 115.

Memory 730 may include any type of dynamic storage device that may store information and/or instructions, for execution by processor 720, and/or any type of non-volatile storage device that may store information for use by processor 720. For example, memory 730 may include a random access memory (RAM) or another type of dynamic storage device, a read only memory (ROM) device or another type of static storage device, and/or a removable form of memory, such as a flash memory. Storage device 740 may include any type of on-board device suitable for storing large amounts of data, and may include one or more hard drives, solid state drives, and/or various types of redundant array of independent disk (RAID) arrays. In an embodiment, storage device 740 may store profile data associated with UEs 130.

Network interface 750 may include a transceiver that enables network device 700 to communicate with other devices and/or systems in network environment 100. Network interface 750 may be configured to exchange data with external network 115 over wired communications (e.g., communication over conductive wire, twisted pair cable, coaxial cable, transmission line, fiber optic cable, and/or waveguide, etc.), or a combination of wireless and wired communications. In other embodiments, network interface 750 may interface with a wide area network using a wireless communications channel, such as, for example, RF, infrared, and/or visual optics, etc. Network interface 750 may include a transmitter that converts baseband signals to RF signals and/or a receiver that converts RF signals to baseband signals. Network interface 750 may be coupled to one or more antennas for transmitting and receiving RF signals. Network interface 750 may include a logical component that includes input and/or output ports, input and/or output systems, and/or other input and output components that facilitate the transmission/reception of data to/from other devices. For example, network interface 750 may include a network interface card (e.g., Ethernet card) for wired communications and/or a wireless network interface (e.g., a WI-FI) card for wireless communications. Network interface 750 may also include a universal serial bus (USB) port for communications over a cable, a Bluetooth® wireless interface, and RF identification device (RFID) interface, a near field communications (NFC) wireless interface, and/or any other type of interface that converts data from one form to another form.

As described below, network device 700 may perform certain operations in response to processor 720 executing software instructions contained in a computer-readable medium, such as memory 730 and/or storage device 740. The software instructions may be read into memory 730 from another computer-readable medium or from another device. The software instructions contained in memory 730 may cause processor 720 to perform processes described herein. Alternatively, hardwired circuitry may be used in place of, or in combination with, software instructions to implement processes described herein. Thus, implementations described herein are not limited to any specific combination of hardware circuitry and software. In an embodiment, the software instructions and/or hardware circuitry may perform the process exemplified by the signal flows in FIGS. 4A and 4B and the flow chart shown in FIG. 5.

Although FIG. 7 shows exemplary components of network device 700, in other implementations, network device 700 may include fewer components, different components, additional components, or differently arranged components than depicted in FIG. 7.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of signal flows have been described with respect to FIG. 4A through 5B, and a series of blocks have been described with respect to FIG. 6, the order of the blocks and/or signal flows may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving, by a first network device in an access network, a request to setup a radio access bearer (RAB) for use in establishing a packet data network (PDN) connection with a user equipment (UE),
wherein the request includes at least one Quality-of-Service (QOS) attribute associated with the request;
determining, by the first network device, whether the at least one QoS attribute is supported by the access network;
sending, by the first network device and to a second network device in a core network, a notification that RAB setup has failed,
wherein the notification includes a cause indicator that indicates that the failure is caused by an unsupported QOS;
modifying, by the core network and in response to the notification, the request to setup the RAB to include a default QoS attribute that is supported by the access network;
sending, by the second network device and to the first network device, the modified request; and
establishing, by the first network device, the RAB with the UE.

2. The method of claim 1, wherein the access network is operated by a different network operator than the core network.

3. The method of claim 1, wherein the access network comprises a long term evolution (LTE) access network or a 5G access network and the core network comprises an evolved packet core (EPC) or a 5G core (5GC).

4. The method of claim 3, wherein the at least one QoS attribute comprises a QoS Class Identifier (QCI) or a 5G QoS Identifier (5QI).

5. The method of claim 3, wherein the first network device comprises an enhanced node B (eNodeB) and wherein the second network device comprises a mobility management entity (MME).

6. The method of claim 1 wherein the notification comprises an evolved Universal Mobile Telecommunications System (UMTS) Terrestrial Network (E-UTRAN) Radio Access Bearer (E-RAB) Setup Response message.

7. The method of claim 1, wherein modifying the request to setup the RAB to include a default QoS attribute that is supported by the access network comprises:
sending, by a mobility management entity (MME) and to a packet data network gateway (PGW) a modify bearer request that includes the cause indicator and a RAB identifier;
sending, by the PGW and to a policy and charging rules function (PCRF), a credit control request update (CCR-U) that includes the cause indicator and the RAB ID;
generating, by the PCRF and based on the cause indicator, a credit control answer update (CCA-U) that includes a default QoS attribute and the RAB ID;
transmitting, by the PCRF and to the PGW, the CCA-U; and
sending, by the PGW and to the MME, a modify bearer response that includes the RAB ID and the default QoS attribute.

8. The method of claim 7, wherein sending, by the second network device and to the first network device, the modified request, comprises:
sending, by the MME and to the eNodeB, an E-RAB setup request message that includes the RAB ID and the default QoS attribute.

9. The method of claim 8, wherein establishing, by the first network device, the RAB with the UE comprises:
performing, by the eNodeB, radio resource control reconfiguration with the UE to establish the E-RAB based on the default QoS attribute.

10. A system comprising:
an access network having a first one or more devices configured to execute first instructions; and
a core network having a second one or more devices configured to execute second instructions;
wherein the first instructions comprise instructions to:
receive a request to setup a radio access bearer (RAB) for use in establishing a packet data network (PDN) connection with a user equipment (UE),
wherein the request includes at least one Quality-of-Service (QOS) attribute associated with the request;
determine whether the at least one QoS attribute is supported by the access network; and
send, to the second one or more devices, a notification that RAB setup has failed,
wherein the notification includes a cause indicator that indicates that the failure is caused by an unsupported QoS;
wherein the second instructions comprise instructions to:
modify, in response to the notification, the request to setup the RAB to include a default QoS attribute that is supported by the access network; and
send, to the first one or more devices, the modified request.

11. The system of claim 10, wherein the access network is operated by a different network operator than the core network.

12. The system of claim 10, wherein the access network comprises a long term evolution (LTE) access network or a 5G access network, the core network comprises an evolved packet core (EPC) or a 5G core (5GC), and wherein the at least one QoS attribute comprises a QoS Class Identifier (QCI) or a 5G QoS Identifier (5GI).

13. The system of claim 10, wherein the notification comprises an evolved Universal Mobile Telecommunications System (UMTS) Terrestrial Network (E-UTRAN) Radio Access Bearer (E-RAB) Setup Response message.

14. The system of claim 10, wherein the one or more first devices comprise an enhanced node B (eNodeB) and wherein the one or more second devices comprise: a mobility management entity (MME), a packet data network gateway (PGW), and a policy and charging rules function (PCRF).

15. The system of claim 14, wherein the instructions to modify the request to setup the RAB to include a default QoS attribute that is supported by the access network comprises, further comprise instructions to:
send, by the MME and to the PGW, a modify bearer request that includes the cause indicator and a RAB identifier;
send, by the PGW and to the PCRF, a credit control request update (CCR-U) that includes the cause indicator and the RAB ID;
generate, by the PCRF and based on the cause indicator, a credit control answer update (CCA-U) that includes a default QoS attribute and the RAB ID;
transmit, by the PCRF and to the PGW, the CCA-U; and
send, by the PGW and to the MME, a modify bearer response that includes the RAB ID and the default QoS attribute.

16. The system of claim 15, wherein the instructions to send the modified request, comprise instructions to:
send, by the MME and to the eNodeB, an E-RAB setup request message that includes the RAB ID and the default QoS attribute.

17. The system of claim 16, further comprising instructions to:
perform, by the eNodeB and in response to the E-RAB setup request message that includes the RAB ID and the default QoS attribute, radio resource control reconfiguration with the UE to establish the E-RAB based on the default QoS attribute.

18. One or more non-transitory computer-readable media storing instructions, the instructions comprising:
one or more instructions that, when executed by a processor, cause the processor to:
receive, by a first network device in an access network, a request to setup a radio access bearer (RAB) for use in establishing a packet data network (PDN) connection with a user equipment (UE),
wherein the request includes at least one Quality-of-Service (QOS) attribute associated with the request;
determine, by the first network device, whether the at least one QoS attribute is supported by the access network;
send, by the first network device and to a second network device in a core network, a notification that RAB setup has failed,
wherein the notification includes a cause indicator that indicates that the failure is caused by an unsupported QoS;
modify, by the core network and in response to the notification, the request to setup the RAB to include a default quality of service attribute that is supported by the access network;
send, by the second network device and to the first network device, the modified request; and
establish, by the first network device, the RAB with the UE.

19. The non-transitory computer-readable media of claim 18, wherein the access network is operated by a different network operator than the core network.

20. The non-transitory computer-readable media of claim 1, wherein the access network comprises a long term evolution (LTE) access network or a 5G access network and the core network comprises an evolved packet core (EPC) or a 5G core (5GC), and
wherein the at least one QoS attribute comprises a QoS Class Identifier (QCI) or a 5G QoS Identifier (5QI).
